(19) United States
(12) Patent Application Publication
(10) Pub. No.: US 2024/0163768 A1
(43) Pub. Date: May 16, 2024

(54) PACKET TRANSMISSION METHOD AND APPARATUS THEREOF

(71) Applicant: MEDIATEK INC., Hsinchu City (TW)

(72) Inventors: Yen-Hsiung TSENG, Hsinchu City (TW); Wei-Wen LIN, Hsinchu City (TW); Chi-Fu KOH, Hsinchu City (TW); Jyh-Ding HU, Hsinchu City (TW); Hui-Ping TSENG, Hsinchu City (TW)

(21) Appl. No.: 18/504,326

(22) Filed: Nov. 8, 2023

Related U.S. Application Data
(60) Provisional application No. 63/383,120, filed on Nov. 10, 2022.

(51) Int. Cl. H04W 40/02; H04L 49/901

(52) U.S. Cl. CPC H04W 40/02; H04L 49/901; H04W 84/12

(57) ABSTRACT

A packet transmission method is provided. The packet transmission method may be applied to an apparatus. The packet transmission method may include the following steps. A path engine circuit of the apparatus may receive a packet from a modem circuit of the apparatus or from a Wi-Fi chip of the apparatus. Then, the path engine circuit may transmit the packet from the modem circuit to the Wi-Fi chip, or transmit the packet from the Wi-Fi chip to the modem circuit or a central processing unit (CPU) of the apparatus.

### CROSS REFERENCE TO RELATED APPLICATIONS

This application claims the benefits of U.S. Provisional Application No. 63/383,120 filed on Nov. 10, 2022, the entirety of which is incorporated by reference herein.

### BACKGROUND OF THE INVENTION

### Field of the Invention

The invention generally relates to wireless communications technology, and more particularly, to packet transmission for Wi-Fi tethering.

### Description of the Related Art

As demand for ubiquitous computing and networking has grown, various wireless technologies have been developed, including Wireless-Fidelity (Wi-Fi) which is a Wireless Local Area Network (WLAN) technology allowing mobile devices (such as a smartphone, a smart pad, a laptop computer, a portable multimedia player, an embedded apparatus, or the like) to obtain wireless services in a frequency band of 2.4 GHz, 5 GHz, 6 Gz or 60 GHz.

The Institute of Electrical and Electronics Engineers (IEEE) has commercialized or developed various technological standards since an initial WLAN technology is supported using frequencies of 2.4 GHz. For example, IEEE 802.11ac supports Multi-User (MU) transmission using spatial degrees of freedom via a MU-Multiple Input-Multiple-Output (MU-MIMO) scheme in a downlink (DL) direction from an Access Point (AP) to Stations (STAs). To improve performance and meet users' demand for high-capacity and high-rate services, IEEE 802.11ax has been proposed, which uses both Orthogonal Frequency Division Multiple Access (OFDMA) and MU-MIMO in both DL and uplink (UL) directions. That is, in addition to supporting frequency and spatial multiplexing from an AP to multiple STAs, transmissions from multiple STAs to the AP are also supported in IEEE 802.11ax.

In the conventional Wi-Fi tethering technology, a host device in the Wi-Fi tethering transmission can provide its network to other devices. However, when the packets for Wi-Fi tethering between the Wi-Fi chip and the modem circuit of the host device need to be transmitted, the CPU of the host device need to be waked up from the sleep mode frequently to process the packet transmission for Wi-Fi tethering. Therefore, the power consumption will be increased. In addition, because the Wi-Fi tethering traffic need to be processed by the CPU of the host device, the latency of packet transmission between software and hardware is inevitable.

Therefore, how to perform packet transmission for Wi-Fi tethering more efficiently and flexibly and reduce the power consumption of the host device in the Wi-Fi tethering transmission is a topic that is worthy of discussion.

### BRIEF SUMMARY OF THE INVENTION

Packet transmission methods and apparatus for packet transmission are provided to overcome the problems mentioned above.

An embodiment of the invention provides a packet transmission method. The packet transmission method may be applied to an apparatus. The packet transmission method may include the following steps. A path engine circuit of the apparatus may receive a packet from a modem circuit of the apparatus or from a Wi-Fi chip of the apparatus. Then, the path engine circuit may transmit the packet from the modem circuit to the Wi-Fi chip, or transmit the packet from the Wi-Fi chip to the modem circuit or a central processing unit (CPU) of the apparatus.

An embodiment of the invention provides an apparatus for packet transmission. The apparatus may include a modem circuit, a Wi-Fi chip, a central processing unit (CPU) and a path engine circuit. The path engine circuit may be coupled to the modem circuit, Wi-Fi chip, and the CPU. In addition, the path engine circuit may be configured to receive a packet from the modem circuit or the Wi-Fi chip, and transmit the packet from the modem circuit to the Wi-Fi chip, or transmit the packet from the Wi-Fi chip to the modem circuit or CPU.

An embodiment of the invention provides an application processor. The application processor may include a central processing unit (CPU) and a path engine circuit. The path engine circuit is coupled to the CPU. In addition, the path engine circuit may be configured to receive a packet from a modem circuit or a Wi-Fi chip, and transmit the packet from the modem circuit to the Wi-Fi chip, or transmit the packet from the Wi-Fi chip to the modem circuit or CPU.

Other aspects and features of the invention will become apparent to those with ordinary skill in the art upon review of the following descriptions of specific embodiments of the packet transmission methods and apparatus for packet transmission.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating a network node according to an embodiment of the application.

FIG. 4 is a schematic diagram illustrating a packet transmission from the modem circuit to the Wi-Fi chip according to an embodiment of the application.

FIG. 5 is a flow chart illustrating a packet transmission method from the modem circuit to the Wi-Fi chip according to an embodiment of the invention.

FIG. 6 is a schematic diagram illustrating a packet transmission from the Wi-Fi chip to the modem circuit according to an embodiment of the application.

FIG. 7 is a flow chart illustrating a packet transmission method from the Wi-Fi chip to the modem circuit according to an embodiment of the invention.

FIG. 8 is a flow chart illustrating a packet transmission method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

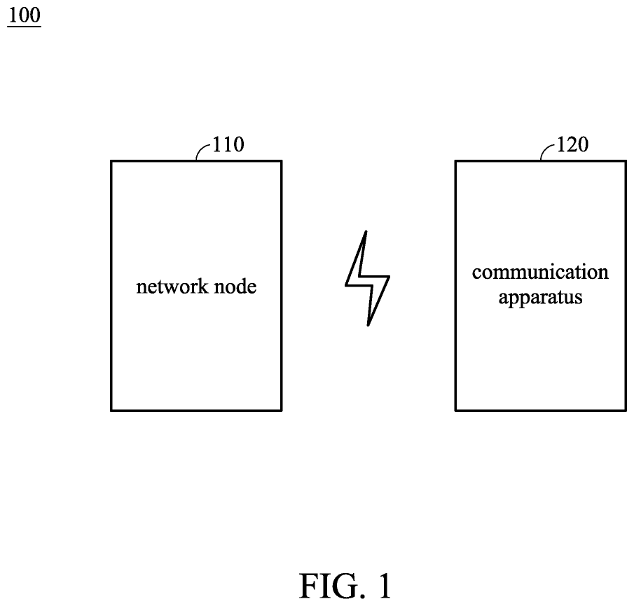

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In the embodiments of the invention, the communication apparatus 120 may be a user equipment (UE), a smartphone, Personal Data Assistant (PDA), pager, laptop computer, desktop computer, wireless handset, or any computing device that includes a wireless communications interface.

In an embodiment of the invention, the network node 110 may be a base station, a gNodeB (gNB), a NodeB (NB) an eNodeB (eNB), an access point, an access terminal, but the invention should not be limited thereto. In the embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto.

In an embodiment of the invention, the communication apparatus 120 may have an access point (AP) function, i.e. Wi-Fi tethering function. That is, the communication apparatus 120 can share its network from the network node 110 to another communication apparatus.

The communication apparatus 120 may be regarded as an entity compatible with the Institute of Electrical and Electronics Engineers (IEEE) 802.11 standards to provide and manage the access to the wireless medium for another communication apparatus. For example, in the embodiment of the invention, the communication apparatus 120 may be regarded as an AP which is compatible with 802.11be standards.

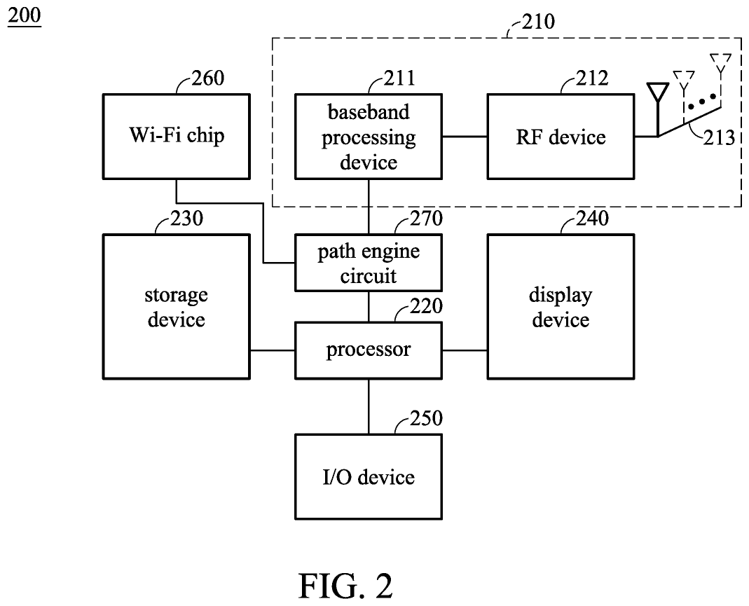

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250, a Wi-Fi chip 260 and a path engine circuit 270. The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the Wi-Fi chip 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application. The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi chip 260 may comprise Wi-Fi antenna and may be configured to perform the operations of Wi-Fi communications.

According to an embodiment of the invention, the path engine circuit 270 may be coupled to the wireless transceiver 210, processor 220 and Wi-Fi chip 260. The path engine circuit 270 may be configured to process the Wi-Fi tethering traffic between the wireless transceiver 210 and the Wi-Fi chip 260.

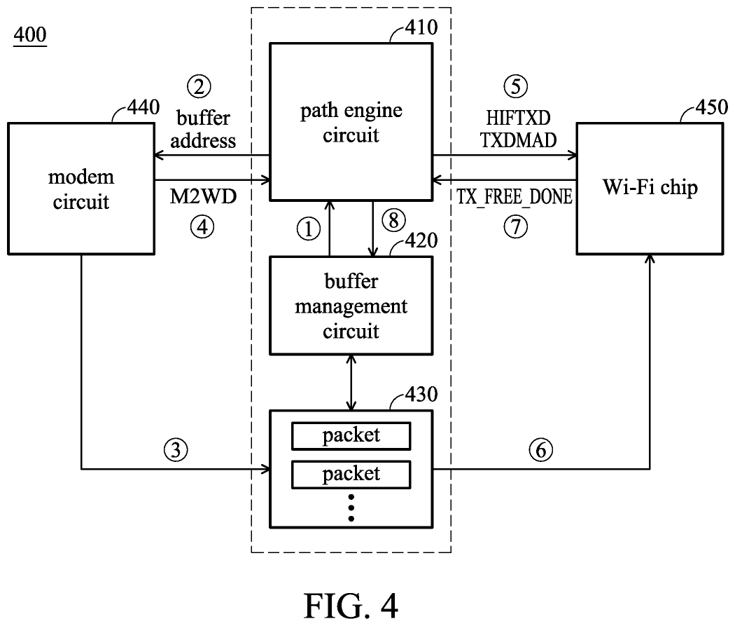

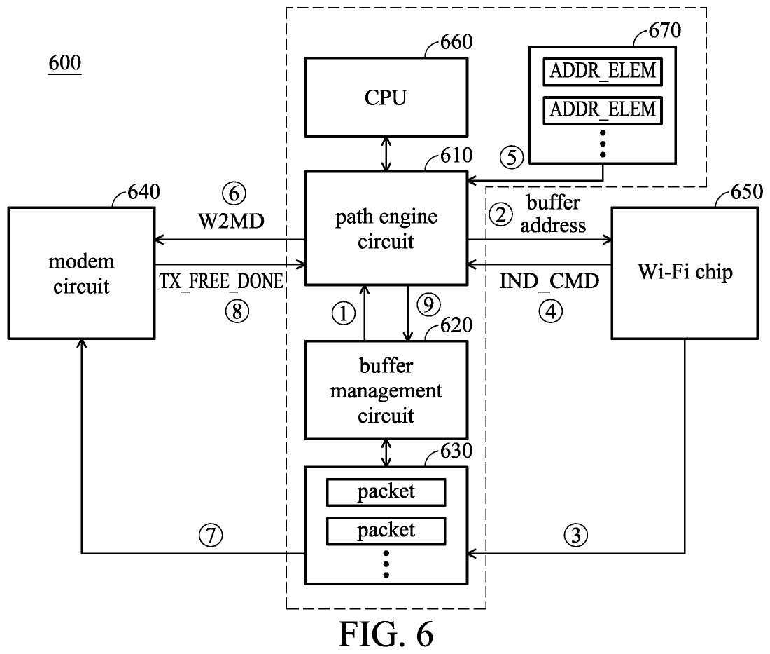

According to an embodiment of the invention, the wireless transceiver 210 may be configured in a modem (MD) (e.g., modem circuit 440 of FIG. 4 and modem circuit 640 of FIG. 6) of the communication apparatus 200, and the processor 220 and the path engine circuit 270 may be configured in an application processor (AP) or a platform of the communication apparatus 200.

In addition, according to an embodiment of the invention, the application processor (AP) may further comprise a buffer management circuit (e.g., buffer management circuit 420 of FIG. 4 and buffer management circuit 620 of FIG. 6) to control and management the operations of a packet buffer (e.g., packet buffer 430 of FIG. 4 and packet buffer 630 of FIG. 6) in the AP, wherein the packet buffer is configured to temporarily store the packets for the Wi-Fi tethering traffic between the wireless transceiver 210 and the Wi-Fi chip 260. In an embodiment, the buffer management circuit may be integrated into the path engine circuit 270. Therefore, in the embodiments of the invention, for tethering transmission, the wireless transceiver 210 and the Wi-Fi chip 260 may not perform extra copy operations in its buffer.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

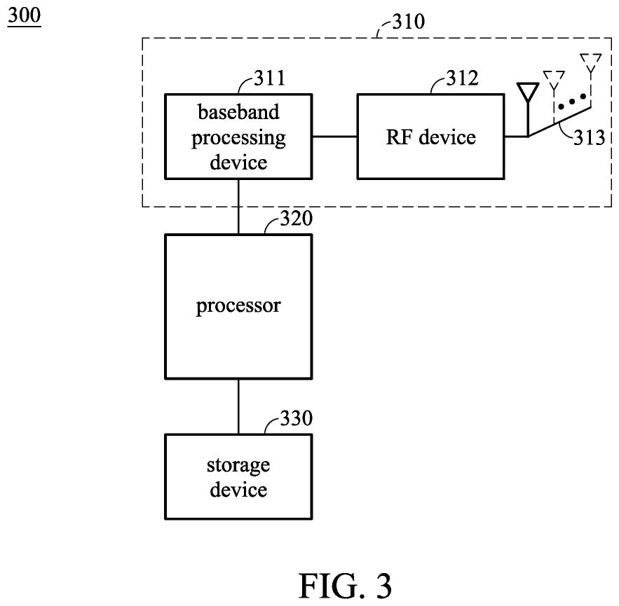

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPH/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, a path engine circuit of the communication apparatus 120 may receive packets from a modem circuit of the communication apparatus 120 or a Wi-Fi chip of the communication apparatus 120. Then, the path engine circuit of the communication apparatus 120 may transmit the packets from the modem circuit of the communication apparatus 120 to the Wi-Fi chip of the communication apparatus 120, or transmit the packet from the Wi-Fi chip of the communication apparatus 120 to the modem circuit of the communication apparatus 120 or a CPU of the of the communication apparatus 120. Details will be illustrated by refereeing to FIG. 4 and FIG. 6 below.

FIG. 4 is a schematic diagram illustrating a packet transmission from the modem circuit to the Wi-Fi chip according to an embodiment of the application. The packet transmission 400 shown in FIG. 4 can be applied to the communication apparatus 120 and communication apparatus 200. It should be noted that, in order to clarify the concept of the invention, FIG. 4 presents the elements relevant to the invention are shown. However, the invention should not be limited to what is shown in FIG. 4.

In an embodiment, the path engine circuit 410, the buffer management circuit 420 and the packet buffer 430 may be configured in an application processor (AP) or platform. In addition, in an embodiment, the buffer management circuit 420 may be integrated into the path engine circuit 410.

As shown in FIG. 4, in step 1, the buffer management circuit 420 may allocate the buffer space of the packet buffer 430, and transmit the buffer allocation to the path engine circuit 410.

In step 2, the path engine circuit 410 may transmit the buffer allocation to the modem circuit 440 to assign buffer addresses to the modem circuit 440. That is, the modem circuit 440 may know which buffer address can be used to write packet based on the buffer allocation.

In step 3, when the modem circuit 440 receives the packets from a network node and needs to transmit the packets to the Wi-Fi chip 450, the modem circuit 440 may write the packets into the packet buffer 430 based on the buffer allocation.

Then, in step 4, the modem circuit 440 may transmit a path descriptor M2WD to the path engine circuit 410. The path descriptor M2WD may indicate that the packets need to be transmitted from the modem circuit 440 to the Wi-Fi chip 450.

In step 5, when the path engine circuit 410 receives the path descriptor M2WD from the modem circuit 440, the path engine circuit 410 may know that the packets need to be transmitted from the modem circuit 440 to the Wi-Fi chip 450. Then, the path engine circuit 410 may parse the packets and transmit a host interface transmission (TX) descriptor HIFTXD and a TX direct memory access (DMA) descriptor TXDMAD to the Wi-Fi chip 450.

Specifically, the path descriptor M2WD may further carry information about the packets that need to be transmitted to the Wi-Fi chip 450. The path engine circuit 410 may obtain the Internet Protocol (IP) headers of the packets according to the path descriptor M2WD. Each IP header may comprise an IP version, a source IP address, and a destination IP address. Then, the path engine circuit 410 may look up a mapping table according to the IP addresses corresponding to the packets from the modem circuit 440 to find the medium access control (MAC) addresses corresponding to the packets. The mapping table may be pre-configured by the CPU. In the mapping table, one IP address may be corresponded to one MAC address, i.e., one source IP address may be corresponded to one source MAC address and one destination IP address may be corresponded to destination MAC address. After the path engine circuit 410 obtains the MAC addresses corresponding to the packets, the path engine circuit 410 may form the Ethernet headers corresponding to the packets according to the MAC addresses corresponding to the packets. Then, the path engine circuit 410 may transmit information of the packets with the Ethernet headers through the host interface TX descriptor HIFTXD and the TX DMA descriptor TXDMAD to the Wi-Fi chip 450. The host interface TX descriptor HIFTXD may indicate the information needed for transmitting the packets with the Ethernet headers, e.g., the transmission settings, buffer address, and so on. The TX DMA descriptor TXDMAD may indicate the descriptor (e.g., packet address, HIFTXD address, and so on) for the DMA controller of the Wi-Fi chip 450 in order to transmit the packets with the Ethernet headers and the host interface TX descriptor HIFTXD from the application processor (AP) to the Wi-Fi chip 450.

In another embodiment, the path engine circuit 410 may further look up different mapping tables corresponding to different IP versions (e.g., IPv4 or IPv6) corresponding to different packets.

In step 6, the Wi-Fi chip 450 may obtain or read the packets with the Ethernet headers from the packet buffer 430 based on the host interface TX descriptor HIFTXD and the TX DMA descriptor TXDMAD.

In step 7, when the Wi-Fi chip 450 has transmitted the obtained packets to another communication apparatus for Wi-Fi tethering successfully, the Wi-Fi chip 450 may transmit a report TX_FREE_DONE to the path engine circuit 410. The report TX_FREE_DONE may indicate that the packets for Wi-Fi tethering have been transmitted successfully.

In step 8, the path engine circuit 410 may indicate the buffer management circuit 420 to release the buffer spaces for the packets in the packet buffer 430.

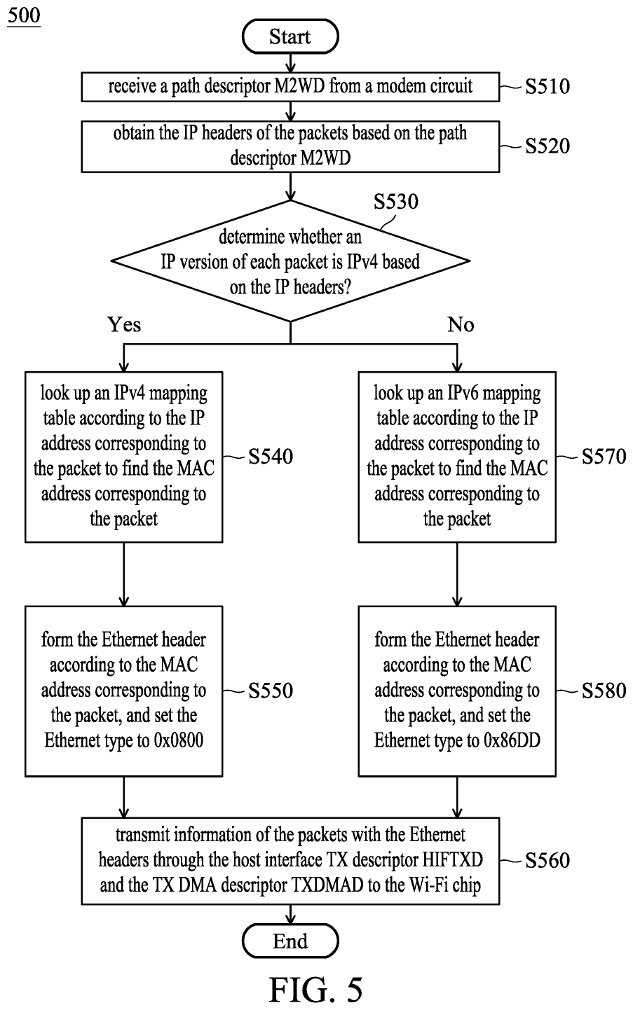

FIG. 5 is a flow chart illustrating a packet transmission method from the modem circuit to the Wi-Fi chip according to an embodiment of the invention. The packet transmission method 500 can be applied in the path engine circuit of the embodiments of the invention. It should be noted that the packet transmission method 500 is only used to illustrate an embodiment of the invention, but the invention should be limited thereto. The order of steps and the number of steps can be adjusted appropriately.

As shown in FIG. 5, in step S510, a path engine circuit may receive a path descriptor M2WD from a modem circuit. The path descriptor M2WD may indicate that the packets need to be transmitted from the modem circuit to a Wi-Fi chip.

In step S520, the path engine circuit may obtain the IP headers of the packets based on the path descriptor M2WD.

In step S530, the path engine circuit may determine whether an IP version of each packet is IPv4 based on the IP headers.

When the IP version of one packet is IPv4, step S540 is performed. In step S540, the path engine circuit may look up an IPv4 mapping table according to the IP address (e.g., a source IP address and a destination IP address in the IP header) corresponding to the packet to find the MAC address (e.g., a source MAC address and a destination MAC address) corresponding to the packet.

In step S550, the path engine circuit may form the Ethernet header according to the MAC address corresponding to the packet, and set the Ethernet type to 0x0800.

When the IP version of one packet is not IPv4 (i.e., is IPv6), step S570 is performed. In step S570, the path engine circuit may look up an IPv6 mapping table according to the IP address (e.g., a source IP address and a destination IP address in the IP header) corresponding to the packet to find the MAC address (e.g., a source MAC address and a destination MAC address) corresponding to the packet.

In step S580, the path engine circuit may form the Ethernet header according to the MAC address corresponding to the packet, and set the Ethernet type to 0x86DD.

In step S560, the path engine circuit may transmit information of the packets with the Ethernet headers through the host interface TX descriptor HIFTXD and the TX DMA descriptor TXDMAD to the Wi-Fi chip.

FIG. 6 is a schematic diagram illustrating a packet transmission from the Wi-Fi chip to the modem circuit according to an embodiment of the application. The packet transmission 600 shown in FIG. 6 can be applied to the communication apparatus 120 and communication apparatus 200. It should be noted that, in order to clarify the concept of the invention, FIG. 6 presents the elements relevant to the invention are shown. However, the invention should not be limited to what is shown in FIG. 6.

In an embodiment, the path engine circuit 610, the buffer management circuit 620, the packet buffer 630, the CPU 660 and the address element interface 670 may be configured in an application processor (AP) or a platform. In addition, in an embodiment, the buffer management circuit 620 may be integrated into the path engine circuit 610.

As shown in FIG. 6, in step 1, the buffer management circuit 620 may allocate the buffer space of the packet buffer 630, and transmit the buffer allocation to the path engine circuit 610.

In step 2, the path engine circuit 610 may transmit the buffer allocation to the Wi-Fi chip 650 to assign buffer addresses to the Wi-Fi chip 650. That is, the Wi-Fi chip 650 may know which buffer address can be used to write packet based on the buffer allocation.

In step 3, when the Wi-Fi chip 650 receives the packets from another communication apparatus and needs to transmit the packets to the modem circuit 640, the Wi-Fi chip 650 may write the packets into the packet buffer 630 based on the buffer allocation.

In step 4, the Wi-Fi chip 650 may transmit a command descriptor IND_CMD to the path engine circuit 610. The command descriptor IND_CMD may carry information about the packets, e.g., the recipient address (RA) of each packet, the traffic identifier (TID) of each packet, the sequence number (SN) of each packet, information of the MAC protocol data units (MPDUs) of the packets, the destination of the packets, and so on. The path engine circuit 610 may determine that the packets need to be transmitted to the modem circuit 640 or the CPU 660 based on the command descriptor IND_CMD and the address information obtained from the address element interface 670. That is, if the packets need to be transmitted to the modem circuit 640, the CPU 660 can stay in the sleep mode to save power.

In addition, in step 5, the path engine circuit 610 may traverse or read the address element interface 670 based on the command descriptor to obtain address information of the packets, e.g., the address information of each MAC service data unit (MSDU) in the MPDUs of the packets, IP information of the packets, the header information of MSDUs of the packets and so on. The address element interface 670 may comprise a plurality of address elements ADDR_ELEM and each packet may correspond to one of the address elements ADDR_ELEM, i.e., each address element may correspond to a sequence number. In addition, when the path engine circuit 610 determines that the packets need to be transmitted to the modem circuit 640, the path engine circuit 610 may traverse all MSDUs of the packets which the address element interface 670 points to and obtain information that modem circuit 640 needs, e.g., header information of MSDUs and other information (or reception statistics) of packets.

In step 6, when the path engine circuit 610 determines that the packets need to be transmitted to the modem circuit 640, the path engine circuit 610 may form a path descriptor W2MD based on the address information obtained from the address element interface 670 and the MSDUs of the packets. The path descriptor W2MD may carry the address information and the MSDUs of the packets. Then, the path engine circuit 610 may transmit the path descriptor W2MD to the modem circuit 640.

In step 7, the modem circuit 640 may obtain or read the packets from the packet buffer 630 based on the path descriptor W2MD.

In step 8, when the modem circuit 640 has transmitted the obtained packets to a network node for Wi-Fi tethering successfully, the modem circuit 640 may transmit a report TX_FREE_DONE to the path engine circuit 610. The report TX_FREE_DONE may indicate that the packets for Wi-Fi tethering have been transmitted successfully.

In step 9, the path engine circuit 610 may indicate the buffer management circuit 620 to release the buffer spaces for the packets in the packet buffer 630.

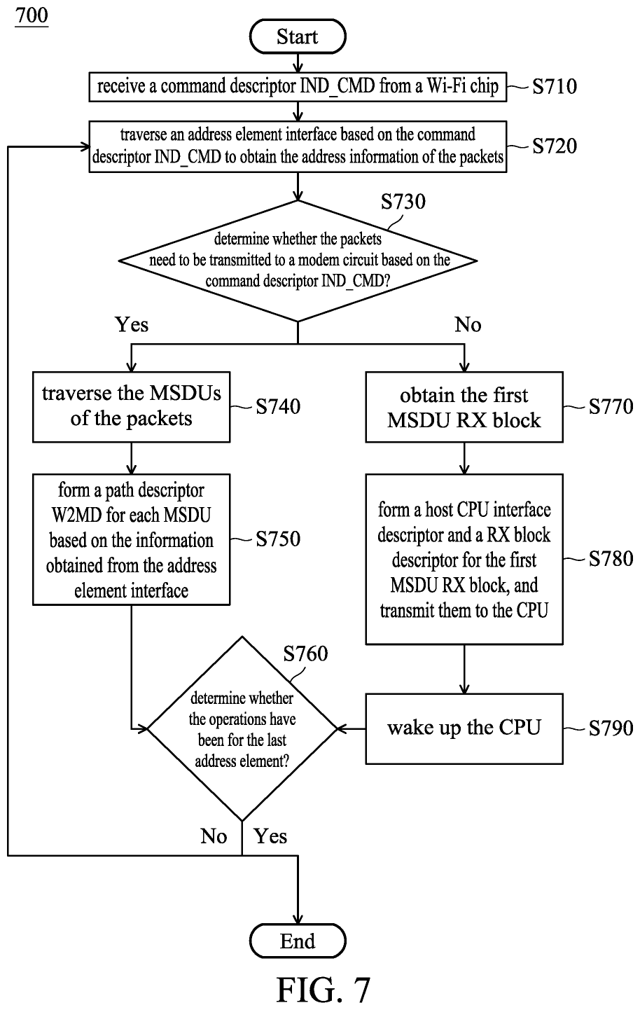

FIG. 7 is a flow chart illustrating a packet transmission method from the Wi-Fi chip to the modem circuit according to an embodiment of the invention. The packet transmission method 700 can be applied in the path engine circuit of the embodiments of the invention. It should be noted that the packet transmission method 700 is only used to illustrate an embodiment of the invention, but the invention should be limited thereto. The order of steps and the number of steps can be adjusted appropriately.

As shown in FIG. 7, in step S710, a path engine circuit may receive a command descriptor IND_CMD from a Wi-Fi chip. The command descriptor IND_CMD may carry the information about the packets which need to be transmitted from the Wi-Fi chip to a modem circuit or a CPU.

In step S720, the path engine circuit may traverse or read an address element interface based on the command descriptor IND_CMD to obtain the address information of the packets, e.g., the address information of each MSDU in the MPDUs of the packets, IP information of the packets, and so on.

In step S730, the path engine circuit may determine whether the packets need to be transmitted to the modem circuit based on the command descriptor IND_CMD and the address information obtained from the address element interface.

If the path engine circuit determines that the packets need to be transmitted to the modem circuit, step S740 is performed. In step S740, the path engine circuit may traverse the MSDUs of the packets which the address element interface points to and obtain information that modem circuit needs, e.g., header information of MSDUs and other information (or reception statistics) of packets.

In step S750, the path engine circuit may form a path descriptor W2MD for each MSDU based on the address information obtained from the address element interface and the MSDUs of packets.

If the path engine circuit determines that the packets need to be transmitted to the CPU, step S770 is performed. In step S770, the path engine circuit may obtain the first MSDU RX block which the address element interface points to.

In step S780, the path engine circuit may form a host CPU interface descriptor and a RX block descriptor for the first MSDU RX block, and transmit the host CPU interface descriptor and the RX block descriptor to the CPU.

In step S790, the path engine circuit may wake up the CPU, i.e., the CPU may leave from the sleep mode.

In step S760, path engine circuit may determine whether the operations of above steps have been for the last address element ADDR_ELEM of the address element interface which the command descriptor IND_CMD indicates. If the operations have not reached the last address element ADDR_ELEM, the packet transmission method 700 goes back to step S720.

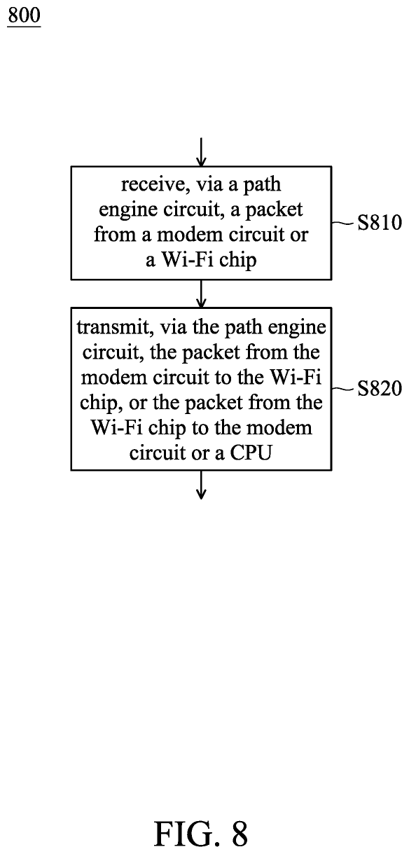

FIG. 8 is a flow chart illustrating a packet transmission method according to an embodiment of the invention. The packet transmission method can be applied to the wireless communication system 100. As shown in FIG. 8, in step S810, a path engine circuit of the communication apparatus 120 of the wireless communication system 100 may receive a packet from a modem circuit of the communication apparatus 120 or a Wi-Fi chip of the communication apparatus 120.

In step S820, the path engine circuit of the communication apparatus 120 may transmit the packet from the modem circuit to the Wi-Fi chip, or transmit the packet from the Wi-Fi chip to the modem circuit or a central processing unit (CPU) of the communication apparatus 120.

According to some embodiments of the invention, in the packet transmission method, the Wi-Fi chip may further receive the packet from another communication apparatus, and write the packet into a buffer of the communication apparatus 120. In addition, the path engine circuit may further receive a command descriptor from the Wi-Fi chip. The command descriptor may carry information of the packet from the Wi-Fi chip. Then, the path engine circuit may determine that the packet needs to be transmitted to the modem circuit or the CPU based on the command descriptor.

According to some embodiments of the invention, in the packet transmission method, the path engine circuit may further travers an address element interface of the communication apparatus 120 based on the command descriptor to obtain address information of the packet, and parse the information of the packet. The address element interface comprises a plurality of address elements and the packet corresponds to one of the address elements.

According to some embodiments of the invention, in the packet transmission method, the path engine circuit may further form a path descriptor carrying the address information obtained from the address element interface and medium access control (MAC) protocol data units (MPDUs) of the packet, in response to determining that the packet needs to be transmitted to the modem circuit. Then, the path engine circuit may further transmit the path descriptor to the modem circuit. Then, the modem circuit may obtain the packet from the buffer based on the path descriptor.

According to some embodiments of the invention, in the packet transmission method, the modem circuit may further receive the packet from a network node and write the packet into a buffer. In addition, the path engine circuit may further receive a path descriptor from the modem circuit to transmit the packet to the Wi-Fi chip.

According to some embodiments of the invention, in the packet transmission method, the path engine circuit may further obtain an Internet Protocol (IP) header of the packet based on the path descriptor. Then, the path engine circuit may further obtain a medium access control (MAC) address of the packet from a mapping table based on the IP header. Then, the path engine circuit may further form an Ethernet header of the packet based on the MAC address.

According to some embodiments of the invention, in the packet transmission method, the path engine circuit may further transmit information of the packet with the Ethernet header to the Wi-Fi chip through a host interface transmission (TX) descriptor and a TX direct memory access (DMA) descriptor. Then, the Wi-Fi chip may further obtain the packet with the Ethernet header from the buffer based on the host interface TX descriptor and the TX DMA descriptor.

According to some embodiments of the invention, in the packet transmission method, the path engine circuit may further receive a report from the Wi-Fi chip or the modem circuit in response to the Wi-Fi chip or the modem circuit having transmitted the packet successfully.

In the packet transmission method provided in the embodiments of the invention, the CPU may stay in sleep mode to save power when the packet transmission is associated with the Wi-Fi tethering traffic between the modem circuit and the Wi-Fi chip. In addition, in the packet transmission method provided in the embodiments of the invention, the modem circuit and the Wi-Fi chip can directly read data from the buffer of the application processor (AP) without performing extra copy operations in its buffer. In addition, in the packet transmission method provided in the embodiments of the invention, the path engine circuit is used to process the packet transmission between the modem circuit and the Wi-Fi chip, and therefore, the latency between software and hardware can be reduced.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A packet transmission method, applied in an apparatus, comprising:
receiving, by a path engine circuit of the apparatus, a packet from a modem circuit of the apparatus or a Wi-Fi chip of the apparatus; and
transmitting, by the path engine circuit, the packet from the modem circuit to the Wi-Fi chip, or the packet from the Wi-Fi chip to the modem circuit or a central processing unit (CPU) of the apparatus.

2. The packet transmission method of claim 1, further comprising:
receiving, by the Wi-Fi chip, the packet from another apparatus;
writing, by the Wi-Fi chip, the packet into a buffer;
receiving, by the path engine circuit, a command descriptor from the Wi-Fi chip, wherein the command descriptor carries information of the packet from the Wi-Fi chip; and
determining, by the path engine circuit, that the packet needs to be transmitted to the modem circuit or the CPU based on the command descriptor.

3. The packet transmission method of claim 2, further comprising:
traversing, by the path engine circuit, an address element interface based on the command descriptor to obtain address information of the packet, wherein the address element interface comprises a plurality of address elements and the packet corresponds to one of the address elements; and
parsing, by the path engine circuit, the information of the packet.

4. The packet transmission method of claim 3, further comprising:
forming, by the path engine circuit, a path descriptor carrying the address information obtained from the address element interface and medium access control (MAC) protocol data units (MPDUs) of the packets, in response to determining that the packet needs to be transmitted to the modem circuit;
transmitting, by the path engine circuit, the path descriptor to the modem circuit; and
obtaining, by the modem circuit, the packet from the buffer based on the path descriptor.

5. The packet transmission method of claim 1, further comprising:
receiving, by the modem circuit, the packet from a network node;
writing, by the modem circuit, the packet into a buffer; and
receiving, by the path engine circuit, a path descriptor from the modem circuit to transmit the packet to the Wi-Fi chip.

6. The packet transmission method of claim 5, further comprising:
obtaining, by the path engine circuit, an Internet Protocol (IP) header of the packet based on the path descriptor;
obtaining, by the path engine circuit, a medium access control (MAC) address of the packet from a mapping table based on the IP header; and
forming, by the path engine circuit, an Ethernet header of the packet based on the MAC address.

7. The packet transmission method of claim 6, further comprising:
transmitting, by the path engine circuit, information of the packet with the Ethernet header to the Wi-Fi chip through a host interface transmission (TX) descriptor and a TX direct memory access (DMA) descriptor; and
obtaining, by the Wi-Fi chip, the packet with the Ethernet header from the buffer based on the host interface TX descriptor and the TX DMA descriptor.

8. The packet transmission method of claim 1, further comprising:
receiving, by path engine circuit, a report from the Wi-Fi chip or the modem circuit in response to the Wi-Fi chip or the modem circuit having transmitted the packet successfully.

9. An apparatus for packet transmission, comprising:
a modem circuit;
a Wi-Fi chip;
a central processing unit (CPU); and
a path engine circuit, coupled to the modem circuit, the Wi-Fi chip, and the CPU, and configured to:
receive a packet from the modem circuit or the Wi-Fi chip; and
transmit the packet from the modem circuit to the Wi-Fi chip, or transmit the packet from the Wi-Fi chip to the modem circuit or the CPU.

10. The apparatus of claim 9, wherein the Wi-Fi chip receives the packet from another apparatus and writes the packet into a buffer, and wherein the path engine circuit further receives a command descriptor from the Wi-Fi chip, wherein the descriptor carries information of the packet from the Wi-Fi chip and determines that the packet need to be transmitted to the modem circuit or the CPU based on the command descriptor.

11. The apparatus of claim 10, wherein the path engine circuit further traverses an address element interface based on the command descriptor to obtain address information of the packet, wherein the address element interface comprises a plurality of address elements and the packet corresponds to one of the address elements and parses the information of the packet.

12. The apparatus of claim 11, wherein the path engine circuit further forms a path descriptor carrying the address information obtained from the address element interface and medium access control (MAC) protocol data units (MPDUs) of the packets, in response to the path engine circuit determining that the packet needs to be transmitted to the modem circuit, and transmits the path descriptor to the modem circuit, and the modem circuit obtains the packet from the buffer based on the path descriptor.

13. The apparatus of claim 9, wherein the modem circuit receives the packet from a network node and writes the packet into a buffer, and wherein the path engine circuit further receives a path descriptor from the modem circuit to transmit the packet to the Wi-Fi chip.

14. The apparatus of claim 13, wherein the path engine circuit further obtains an Internet Protocol (IP) header of the packet based on the path descriptor, obtains a medium access control (MAC) address of the packet from a mapping table based on the IP header, and forms an Ethernet header of the packet based on the MAC address.

15. The apparatus of claim 14, wherein the path engine circuit further transmits information of the packet with the Ethernet header to the Wi-Fi chip through a host interface transmission (TX) descriptor and a TX direct memory access (DMA) descriptor, and the Wi-Fi chip obtains the packet with the Ethernet header from the buffer based on the host interface TX descriptor and the TX DMA descriptor.

16. The packet transmission method of claim 1, wherein the path engine circuit further receives a report from the Wi-Fi chip or the modem circuit in response to the Wi-Fi chip or the modem circuit having transmitted the packet successfully.

17. An application processor, comprising:
a central processing unit (CPU); and
a path engine circuit, coupled to the CPU, and configured to:
receive a packet from a modem circuit or a Wi-Fi chip; and
transmit the packet from the modem circuit to the Wi-Fi chip, or transmit the packet from the Wi-Fi chip to the modem circuit or the CPU.

18. The application processor of claim 17, wherein the path engine circuit further receives a command descriptor from the Wi-Fi chip, wherein the descriptor carries information of the packet from the Wi-Fi chip and determines that the packet need to be transmitted to the modem circuit or the CPU based on the command descriptor, wherein the path engine circuit further traverses an address element interface based on the command descriptor to obtain address information of the packet, wherein the address element interface comprises a plurality of address elements and the packet corresponds to one of the address elements, and the path engine circuit further forms a path descriptor carrying the address information obtained from the address element interface and medium access control (MAC) protocol data units (MPDUs) of the packet, in response to the path engine circuit determining that the packet needs to be transmitted to the modem circuit, and transmits the path descriptor to the modem circuit.

19. The application processor of claim 17, wherein the path engine circuit further receives a path descriptor from the modem circuit to transmit the packet to the Wi-Fi chip, and wherein the path engine circuit further obtains an Internet Protocol (IP) header of the packet based on the path descriptor, obtains a medium access control (MAC) address of the packet from a mapping table based on the IP header, forms an Ethernet header of the packet based on the MAC address, and transmits information of the packet with the Ethernet header to the Wi-Fi chip through a host interface transmission (TX) descriptor and a TX direct memory access (DMA) descriptor.

20. The application processor of claim 17, further comprising:
a buffer management circuit, coupled to the path engine circuit and configured to control a buffer which the packet is written into and read from.
